(19) United States
(12) Patent Application Publication
(10) Pub. No.: US 2015/0308417 A1
(43) Pub. Date: Oct. 29, 2015

(54) KINETIC TRACTION DEVICE GENERATED BY ECCENTRIC MOTIONS

(71) Applicant: Tullio Rismondo, Trieste (IT)

(72) Inventor: Tullio Rismondo, Trieste (IT)

(21) Appl. No.: 14/650,129

(22) PCT Filed: Dec. 3, 2013
(86) PCT No.: PCT/IT2013/000336

§ 371 Date: Jun. 5, 2015

(30) Foreign Application Priority Data
Dec. 5, 2012 (IT) GO2012A000011

(51) Int. Cl. F03G 3/00

(52) U.S. Cl. CPC F03G 3/00

(57) ABSTRACT

The device consists of two sets of twin eccentric groups (1, 2, 3, 4) in a specular way mounted on two support plates. It gives a non-reactive propulsion, generated by a gyroscopic drift. The discs (16, 23, 14) of the eccentric groups (1, 2, 3, 4) are operated by a series of distribution gears (8, 9, 10, 11, 12, 13) by implementing the gemmation of a mass heavily eccentric. The clear loss of angular speed caused by this is contrasted and supported by the external torque provided by a preferably electric engine. This operation repositions the barycentre and shifts the mass centre. Appropriate phase manoeuvres, first consolidate the transformation of the additional momentum in kinetic energy, which exerts traction on the mass centre, and then allows the conservation of the remaining momentum of the system, by recomposing the discs (16, 23, 14) at a gradually increasing angular speed.

### FIELD OF APPLICATION

The invention consists of an eccentric motion device that uses a new propulsion system for watercrafts, but also other vehicles on low adherent grounds, such as snow, mud, marsh, in addition to air and space means of transport.

### BACKGROUND OF THE INVENTION

Rotating machines are subject to drift eccentric motions caused mainly by constructive defects, simply dismissed on a conceptual level, as undesirable sources of vibration, asymmetries or displacements (the so-called gyroscopic drift).

This often requires mechanical corrective devices, such as shafts against rotors and counter-weights when it is impossible or too expensive to eliminate these forces from a constructional point of view.

A progress worthy of noting as the solution to these issues has been described in WO2006106375 that illustrates a device equipped with at least four twin eccentric groups, a series of distribution gears, a manoeuvre control system, a plate and a stall mechanism. Distribution gears convey the motion from a preferably electrical engine to the eccentric groups. Half of the latter is in the opposing phase (clockwise and anti-clockwise rotations) and the other half in the phase delay that is 180° out of phase in relation to the first half. It is possible to obtain a non-impulsive motion of the mass centres with a uniform thrust by assembling more eccentric twin groups (at least four), with different phases and rotation direction. In each system composed of four eccentric groups, these are places at the corners of a virtual square. With this device having a phase manoeuvring system, these are only automatic, making it impossible to always execute different manual manoeuvres.

### SUMMARY OF THE INVENTION

The purpose of this invention is to offer to its users a kinetic traction device, an improved version of the one described in WO2006106375, having a configuration that will increase the phase manoeuvres (up until now exclusively automatic), therefore always allowing different manual manoeuvres, suitable for producing steer and thrust inversions.

As better explained in the patent claims, these are just some of the purposes of this device, which shall include at least four eccentric twin groups, at least one support plate, a series of distribution gears, at least one structure to control the phase manoeuvres and one specific stall device for each group. Each support plate is the basis of at least four eccentric groups. This device makes use of the torque provided by the engine and conveyed by the distribution gears. Looking in more in detail, the torque is conveyed to a driver gear to at least one pinion and from each pinion, through at least two crown wheels, to a minimum of four engine gears. Each engine gear causes the rotation of one eccentric group. Another engine gear is to be operated by another pair of crown wheels. The driver gear and the pinion pivot are both on support plates.

Each eccentric group includes a base complex, at least one eccentric complex and a plate or a foil shaped as a massive disc with an axle. Half of the eccentric groups are in the opposite phase (clockwise and anti-clockwise rotation) and the other half is in phase delay.

The base complex of each eccentric group is composed of a plate or disc-shaped foil, of a first axle and second axle and of four gears controlling the elongation and grouping of the eccentric complex. The disc of each base complex has a central loop and two other holes in eccentric position and at the vertex of an equilateral triangle having the central hole as the third vertex. One end of the first axle of the base complex passes through the hole on the support plate, whereas the other end is inserted into the central hole of disc of the base complex and fastened orthogonally to the disc. The first end of the first axle of the base complex is linked to an engine gear. The second hole in the disc of each base complex holds the first end to the second shaft of the base complex, which is also secured to the disc. On the second end of the second shaft of the base complex there is a free first gear. This first gear is attached to a second gear pivoted on the first shaft of the base complex. Every gear is temporarily coupled with a third gear, which is also fitted together with the first shaft of the base complex.

The eccentric complex of each eccentric group includes a plate or a disc-shaped foil, the first shaft of the eccentric complex, the second shaft of the eccentric complex and three gears. The disc of each eccentric complex has three holes. The first end of the first guide shaft of the eccentric complex is secured in the first eccentric hole; the first end of the second shaft of the eccentric complex is secured in the second central hole and the abovementioned shaft of the third massive disc rotates freely in relation to the disc of the eccentric complex, which is integral to the third massive disc and constitutes to its support and guidance. The three holes on the disc of the eccentric complex are located the same distance; having the same diameter. The first hole is opposite the third hole in relation to the second hole. The second end of the first guide shaft of the eccentric complex goes through the second eccentric hole on the disc of the base complex. The first guide shaft rotates freely in relation to the disc of the base complex. The first free gear on the second shaft of the base complex is also attached to the fourth gear, which is fastened to an end of the first guide shaft of the eccentric complex. The first guide shaft of the eccentric complex also goes through a first gear of the eccentric complex, located between the disc of the base complex and the disc of the eccentric complex and secured to the disc of the base complex. The first gear of the eccentric complex is attached to the second gear of the eccentric complex that transfers and inverts the motion, it is pivoted on the second end of the second shaft of the eccentric complex. In its turn, the second gear of the eccentric complex is attached to the third gear of the eccentric complex, which is secured to the end of the shaft of the third massive disc located between the disc of the base complex and the disc of the eccentric complex. The three gears of the eccentric complex are coplanar.

For each support plate the manoeuvre control system includes two plates equipped with at least two pairs of toothed racks on two sides, operated by cams. Cams are placed in pairs and are rotated integrally with the shaft of the driver gear. The two cams are out of phase by 180° with each other. The racks are placed on the same level as the cams; the plates with pairs of racks are coupled with each support plate through some sliding joints that allow movement only in one direction. Every cam is directly or indirectly located in contact with a plate including a couple of racks. Their contact is ensured by the presence of compression springs. The plate with a couple of racks is positioned on the same side as the support plate on which the eccentric groups are mounted. The driver gear operates simultaneously with the pair of racks and each one of the racks is engaged with its two sides to the opposed sides of the gears of two eccentric groups. The third gear of the base complex of each eccentric group, which is fitted to the first shaft of the base complex, is secured to the support plate with couples of racks and is displaced only during the phase manoeuvres. Rack plates can be also operated by electro-hydraulic or electro-mechanical actuators.

The mechanism for stalling conditions consists of a rocker for each eccentric group. Each rocker is composed of an shaft, fixed to the support plate, on which the first and second rocker arms are secured. The first rocker arm is located between the first and the second gear of the first shaft of the base complex. A knife plate is fixed to the first rocker arm and a spring (fastened to the support plate) is linked to the second rocker arm. The second rocker arm is located in a position that can be reached and operated from the massive eccentric disc.

Each plate or plate of the base, eccentric or massive eccentric complex can also have other geometrical shapes, regular or irregular.

The device is inserted in a solid metal container, with a limit profile corresponding at least to the width and length of one of the support plates it contains. Profitably, the best proportions are done on a ratio of 6×7×1. The eccentric groups and manoeuvre control system are located on one side of each support plate, whereas distribution gears are located on the other side of the support plate. The external engine (preferably electrical) is joined by means of the Torx socket on the side of the driver gear. The container is to be airtight, with perimeter eyelets to secure it to the vehicle or to the mobile structure.

Profitably, a set of twin eccentric groups of a support plate is mounted symmetrically to a second set of twin eccentric groups on another support plate, so as to match the third massive disc. Every set has the same number of eccentric groups.

In this way, mechanical problems of embossed masses in the maximum extension position can be avoided. The two sets of eccentric groups have different distributions, but a common motion source. The massive discs of two symmetrical eccentric groups can be replaced by just one massive disc of the total weight.

The device with four eccentric groups, composed of two pairs out of phase by 180° is already balanced, but it can also use three couples of eccentric groups put of phase by 120° or four couples of eccentric groups out of phase by 90° . This would keep the same performance, but considerably increase the balance, the splitting and use more compact and light mechanisms such as shafts and gears share the previous stress even though at the expense of a much more complex mechanism.

The installation is completely mechanical and adopts a remarkable engineering construction and simplification, as it has only three kinds of components, preferably only one measure for seven distribution gears, preferably one measure for the synchronisation phase of the gears of the discs and of one measure for the metal discs.

The device gives a non-reactive propulsion generated by eccentric motions. Its originality is based on the constructive structure that takes eccentric masses far from the rotation centre with a constant angular speed in spite of the increase in distance between the said centre and where the massive disc is concentrated, by using high-density materials such as tungsten for the terminal eccentric disc called “massive” (third) disc and low-density materials such as aluminium for the other discs. The massive disc weights up to three times the weight of all the suspended masses and takes its barycentre at a distance equal to several times its ray.

This device can give a propulsion suitable to be used in the nautical and terrestrial sector (in a broad sense), on grounds with low adherence such as snow and mud, as an auxiliary system of particular thrusts, such as those provided by stern and bow propellers. In this way it is possible to avoid useless drilling of the hull, or, if the device is located directly on the bulb of the bottom of sailing boats, to alter the hydrodynamics of the hull. The device can also be effectively used on lifeboats that should not have dangerous propellers immersed in water and for all applications that require an airtight propulsion (sailing boat keels, underwater crafts with video cameras for the inspection of nets or underwater cables, that easily hitch in propellers) that does not require any support base or thrust base outside contact.

This device has the peculiarity of allowing manoeuvres in respect to the motion direction, a kind of steering, without physically intervening on the position of the device or its external fastening, but only changing the internal positions of reference of the thrust. Thanks to this, it can be used in positions not accessible for inspection (bottom bulb, etc.) where the stall possibility and motion inversion are very useful. The motion inversion is a complete braking of propulsion, without any manoeuvre or operation with the rotation of the engine (preferably electrical), obtaining therefore an inverse thrust, a completely new innovation in the nautical sector.

This engine adopts a transmission system with an absolutely unconventional power that uses gears to move the wheels of the vehicle, a caterpillar, a propeller or other. In short, the system is a gyroscope, or even better one or two couples of counter-rotating gyroscopes, turning in neutral and receiving a minimal torque of an engine or upstream flywheel. If the symmetrical and concentric settings are interrupted by an appropriate phase manoeuvre, the particular mechanism will enucleate the eccentric mass, which would inevitably slow down the rotation of the system. An extremely original feature of this kind of transmission is that the total torque absorbed by the “engine (created and allowed by the same mechanisms) is exclusively used to keep a constant angular speed, throughout the first half of the rotation cycle. Once the maximal eccentricity and energy absorption has been achieved, the same mechanism will start closing the device by reducing the eccentricity, the angular speed (which would otherwise remain constant, locked up by the above-mentioned mechanisms) with the next phase manoeuvre, facilitating in this way the conservation of momentum. A gyroscope (which in certain conditions shows eccentricity and in a “discontinuous” manner allowing one external force to supply the first half-cycle with the energy needed to keep the angular speed and facilitating the second half-cycle to obtain an increase in the angular speed so as to maintain the rotational momentum) will be subject to a completely induced gyroscopic drift, equal to the energy taken by the engine and exclusively dedicated to this, except for the mechanical frictions of the device.

The eccentric motion device using the innovative propulsion system described in WO2006106375 has been improved in the device described in this patent, thanks to the efficient use of the aforesaid cam and rack system.

### BRIEF DESCRIPTION OF THE DRAWINGS

Other features and advantages of this invention will be revealed in the description of the two ways of execution (favourite but not exclusive) of this device, illustrated only as an example and not in a limitative way in the attached drawings:

FIG. 1 shows the view of the distribution gears of the device in a first Way of execution;

FIG. 2 shows the lateral view of the device in FIG. 1 on the A-A plane;

FIG. 3 shows the section of an eccentric group on the B-B plane;

FIGS. 4 and 5 show two sections of an eccentric group on the D-D and E-E planes;

FIG. 6 shows a section of an eccentric group on the C-C plane;

FIG. 7 shows a section of a part of an eccentric group on the F-F plane;

FIG. 8 shows the top view of the eccentric group;

FIGS. 9, 10, 11, 12 show the operating cycle of an eccentric group;

FIG. 13 shows the top view of the device in a first Way of execution;

FIG. 14 shows the top view of the device in a first Way of execution during the steering phase;

FIG. 15 shows the top view of an eccentric group and its stall mechanism;

FIG. 16 shows a lateral view of an eccentric group and its stall mechanism;

FIG. 17 shows the manoeuvre control system;

FIG. 18 shows a stylised cycle of movements of the discs in the eccentric groups;

FIGS. 19, 20 and 21 show in a more detailed way the manoeuvre control system;

FIG. 22 shows a lateral view of the device in a second Way of execution;

FIG. 23 shows another lateral view of the device in FIG. 22;

FIG. 24 shows a front view of the device in FIG. 22;

FIG. 25 shows a perspective view of the device in FIG. 22.

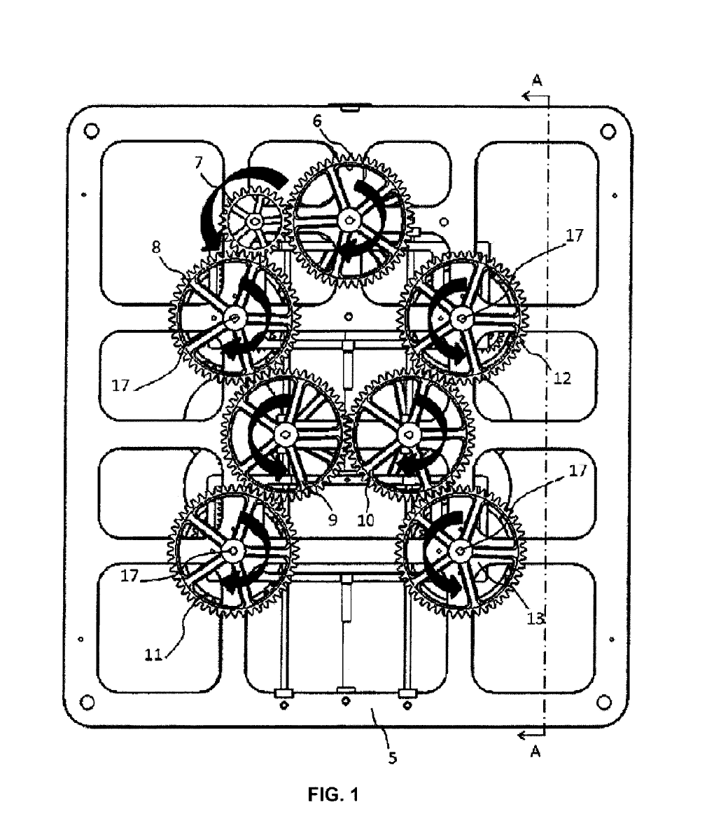

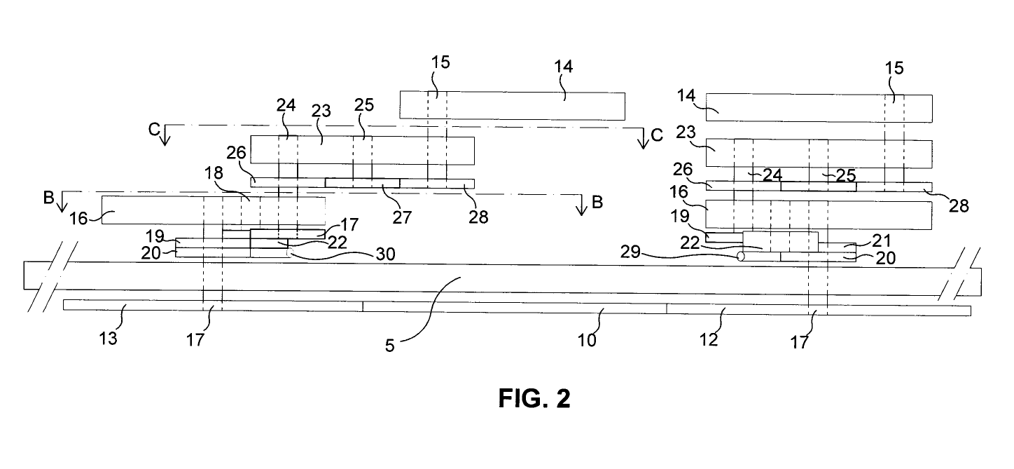

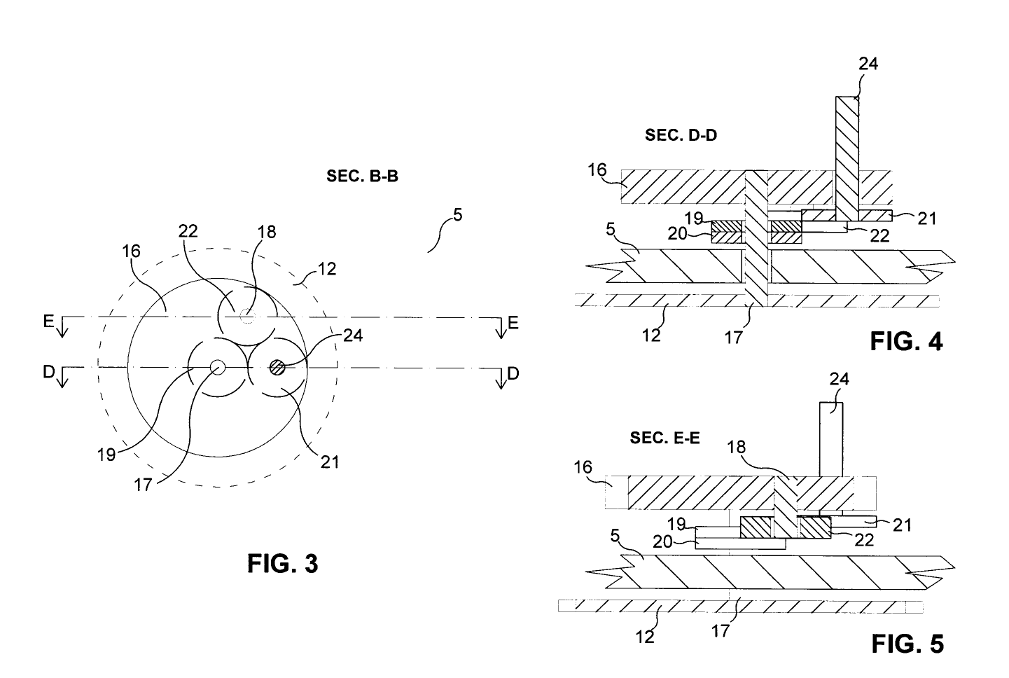

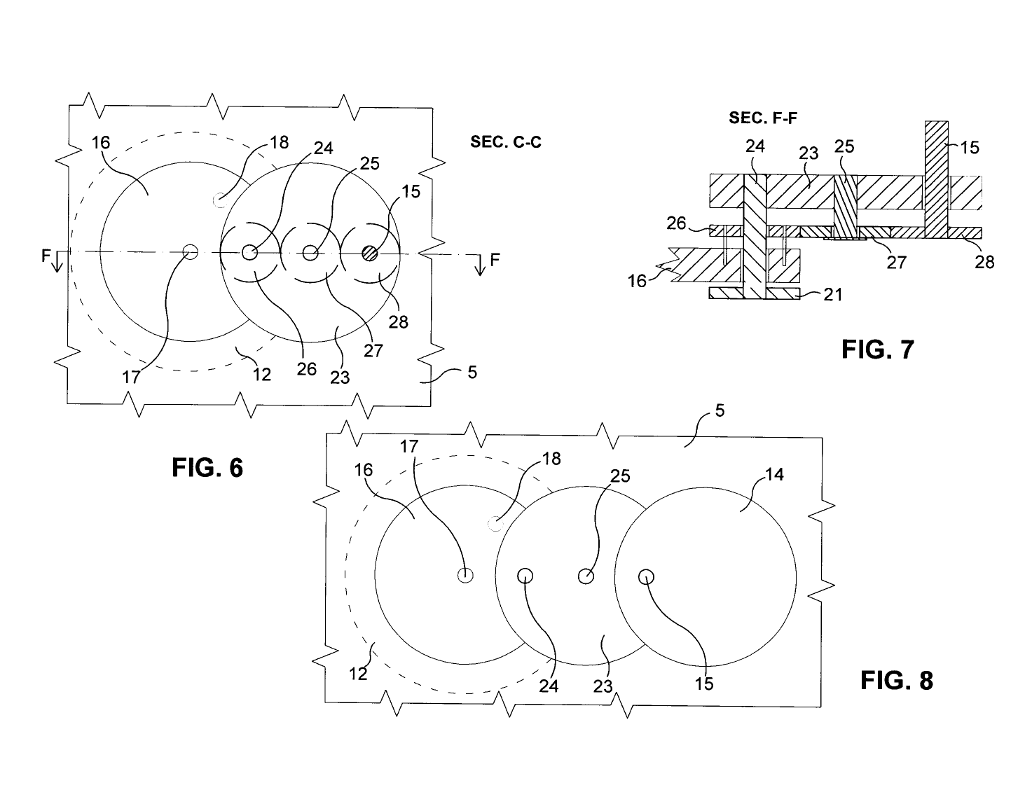

### DETAILED DESCRIPTION OF TWO PREFERRED EMBODIMENTS

More in detail and with reference to the attached drawings, the device illustrated in the first example of execution includes four twin eccentric groups (1, 2, 3, 4), a series of distribution gears, a control system of the phase manoeuvres, a support plate (5) and a stall device.

The support plate (5) constitutes as the basis of the device. The eccentric groups (1, 2, 3, 4) are located on top of the plate in the corners of a virtual square.

This device uses the torque from an electric engine that is transmitted to the distribution gears. In detail the torque is transmitted by a driver gear (6) to a pinion (7), both of them pivoting on top of the support plate (5).

The pinion (7) is joined with an engine gear (8), which in turn is joined to the crown wheel (9). The crown wheel (9) joins to another crown wheel (10) and another engine gear (11). The crown wheel (10) is in turn coupled with two engine gears (12, 13). Every engine gear (8, 11, 12,13) rotates an eccentric group (1, 2, 3, 4).

The six distribution gears (8, 9, 10, 11, 12, 13) are located on the same level, just some millimetres under the support plate 5 and are all identical.

Every eccentric group (1, 2, 3, 4) includes a base complex, an eccentric complex and a massive disc (14) equipped with shaft 15.

The base complex of each eccentric group (1, 2, 3, 4) is composed of a disc 16, a first shaft 17 of the base complex, a second shaft 18 of the base complex and four gears 19, 20, 21, 22. In disc 16 in every base complex there is a central hole. The first end of the first shaft 17 of the base complex goes through a hole in the support plate 5, whereas the other end is inserted into the abovementioned central hole of disc 16 and secured orthogonally to it. The disc 16 of the base complex has two further holes, both in eccentric positions and located at the vertexes of an equilateral triangle having as its third vertex the first hole. The second hole is located at the first end of the second shaft 18 of the base complex, which is also secured to disc 16 of the base complex. On the second end of the second shaft 18 of the base complex, gear 22 is free and joins onto gear 19, which fits onto the first shaft 17 of the base complex. Each gear 19 is temporarily connected, except during stall manoeuvres, to gear 20 fitted to the first shaft of the base complex.

The eccentric complex of each eccentric group 1, 2, 3, 4 includes a disc 23, a first shaft 24 of the eccentric shaft, a second shaft 25 of the eccentric complex and three gears 26, 27, 28. The disc 23 of each eccentric complex has three holes. The first end of the first guide shaft 24 of the eccentric complex is joined to the first eccentric hole, the first end of the second shaft 25 of the eccentric complex is joined to the second central hole, and the abovementioned shaft 15 of the massive disc 14 rotates freely in the third hole. The three holes in disc 23 of the eccentric complex are located each at the same diameter. The first hole is opposite to the third hole in respect to the second hole. The second end of the first guide shaft 24 of the eccentric complex passes through the second eccentric hole of disc 16 of the base complex and it is free to rotate in respect to the latter. Gear 22 is free on the second shaft 18 of the base complex and is also joined to gear 21, fixed to the first end of the first guide shaft of the eccentric complex.

The first guide shaft 24 of the eccentric complex also passes through gear 26, positioned between disc 16 of the base complex and disc 23 of the eccentric complex. Gear 26 is secured to disc 16 of the base complex. Gear 26 is joined to an inversion gear 27, pivoting on the second end of the second shaft 25 of the eccentric complex. In turn, the inversion gear 27 is joined to a guide gear 28, fitted to the end of shaft 15 placed between disc 16 of the base complex and disc 23 of the eccentric complex. The three gears 26, 27, 28 are coplanar. Shaft 15 rotates freely in respect to disc 23 of the eccentric complex and constitutes a support and guide to the third massive disc 14, to which it is integral.

The three discs 16, 23, 14 are in metal and have the same diameter. Gears 20, 22 of the base complex and gears 26, 27, 28 of the eccentric complex have the same diameter, which is different from the diameter of the two gears 19, 21 placed between disc 16 of the base complex and disc 23 of the eccentric complex.

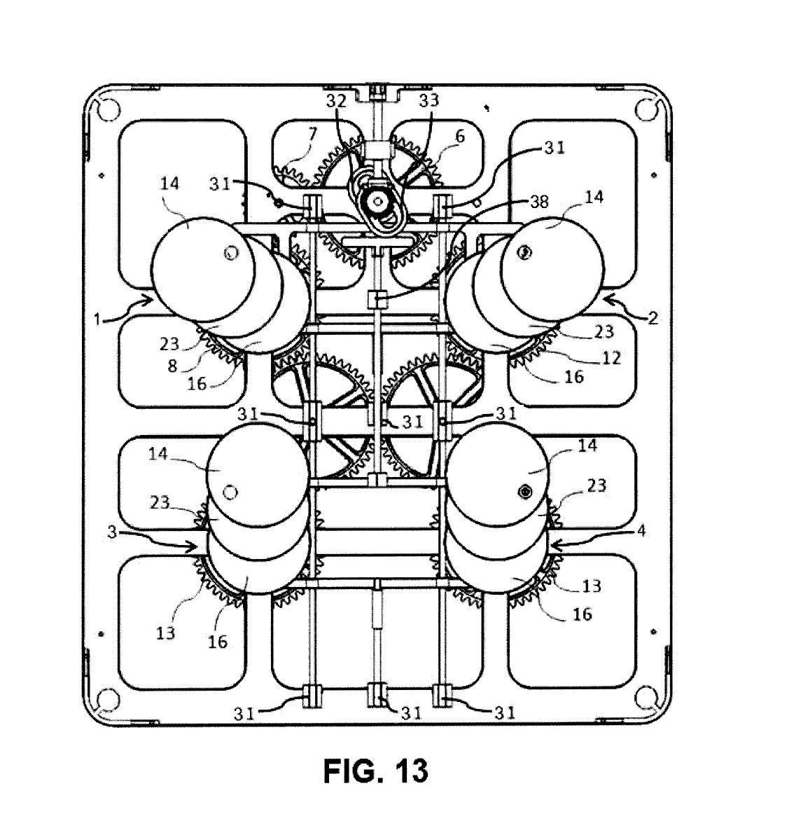

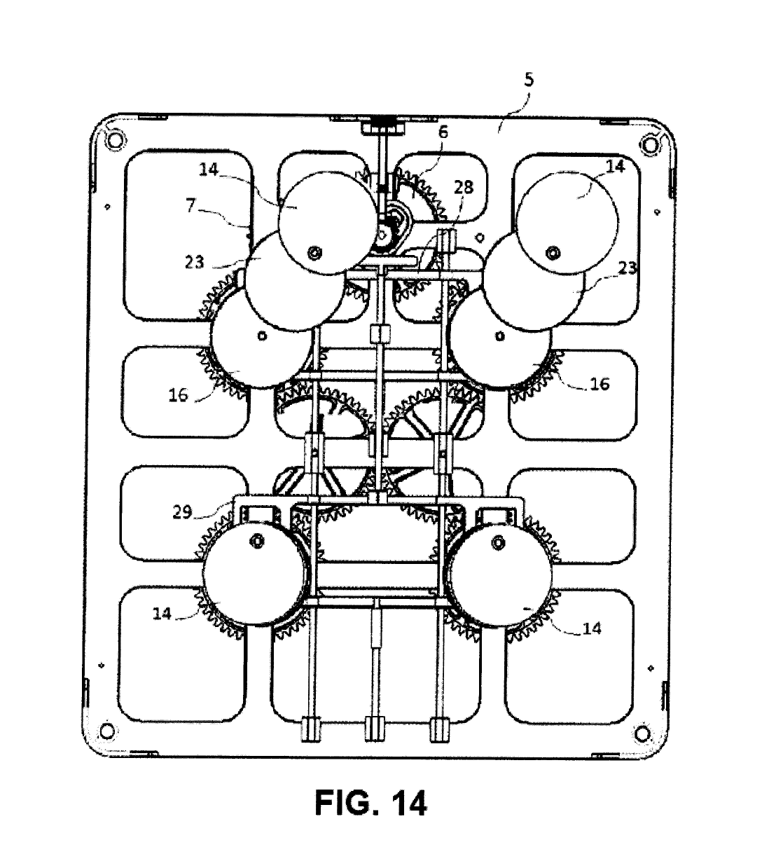

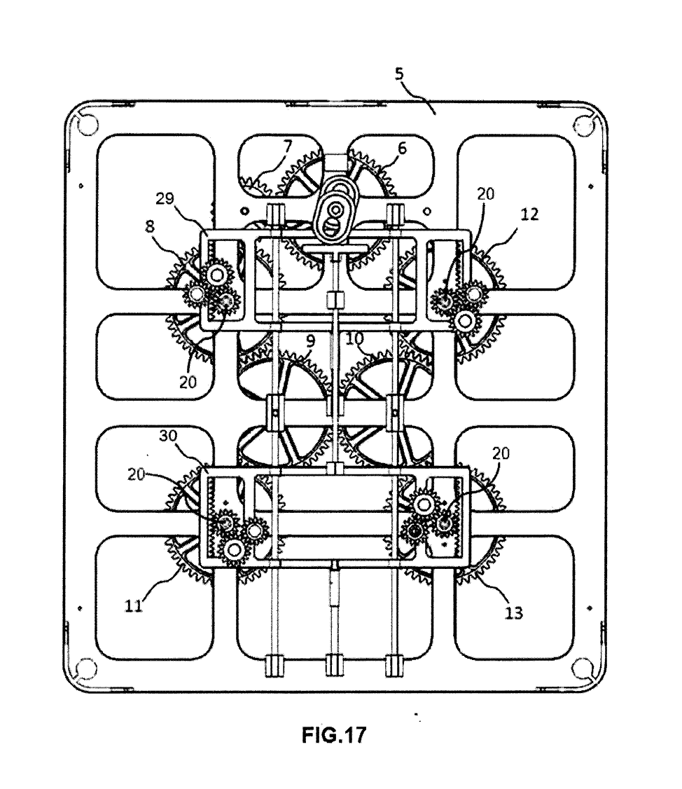

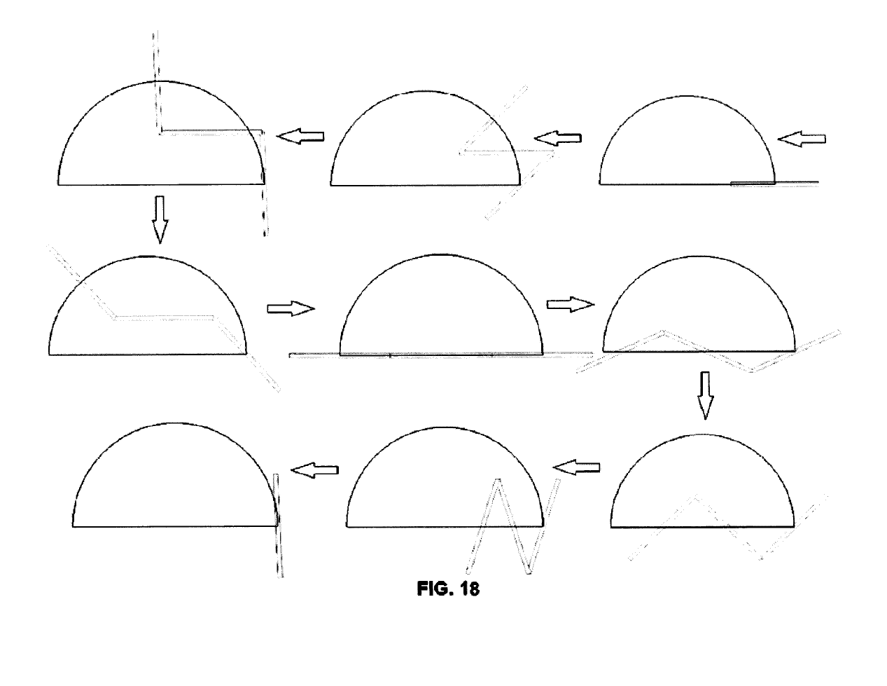

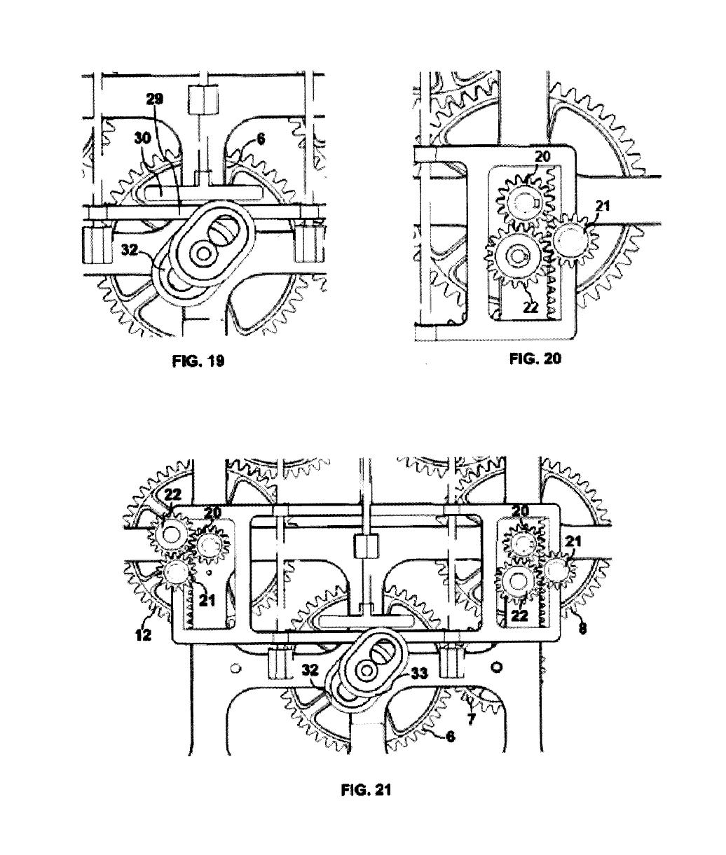

The phase control system includes two rectangular and hollow plates 29, 30. A pair of racks are fastened onto the internal smaller sides of each plate 29, 30. The two plated 29, 30 are linked by means of sliding joints 31 (FIG. 13) with bars fixed to the support plate 5. The sliding joints 31 allow the movement of the two plates 29, 30 only in one direction. The first plate 29 is in contact with the first cam 32 (FIG. 19). A bar with a free end is fixed to a second plate 30, its free enlarged end is in contact with a second cam 33 (FIG. 19, 21). These contacts are constantly assured by the presence of compression springs. Cams 32, 33 are linked and rotate integral with the vertical line shaft of the driver gear 6. Cams 32, 33 are out of phase by 180° in respect to each other. Plates 29, 30 with couple of racks are positioned on top of the support plate 5 (FIGS. 14 and 17). The racks of plates 29, 30 are positioned on the same contiguous level, but overlapping with cams 32, 33. The driver gear 6 operates simultaneously on the couple of plates 29, 30 equipped with racks by means of the two cams 32, 33. Each rack is linked to gear 20 of an eccentric group 1, 2, 3, 4, fitted to the first shaft 17 of each base complex. The pair of racks of each plate 29, 30 is in contact with two gears 20 (FIGS. 17 and 21) of the eccentric groups 1, 2, 3, 4 and, more in particular, the racks on the first plate 29 join to the gears 20 of two eccentric groups 1, 2, and two racks on the other plate 30 engage with gears 20 of the other eccentric groups 3, 4.

The stall mechanism consists in a rocker 34 for each eccentric group 1, 2, 3, 4. Each rocker 34 is composed of a shaft 35, fixed to the support plate 5, on which the first rocker arm 36 and the second rocker arm 37 are secured. The first rocker arm 36 is positioned between gear 19 and gear 20 of the first shaft 17 of each base complex. A knife plate 38 is fixed to the first rocker arm 36 and a spring, connected to the support plate 5 is fixed to the second rocker arm 37. The second rocker arm 37 is located in a place where it can be reached and operated from the massive disc 14, at the end of its rotation.

Effectively, every eccentric group 1, 2, 3, 4 is operated from its first shaft 17 of the base complex, linked to an engine gear 8, 11, 12, 13. Each first shaft 17 of the base complex causes the rotation of disc 16, which is attached to it. This involves the second shaft 18 of the base complex and the first shaft 24 of the eccentric complex in a circular motion having the same rotation direction. As abovementioned, at the end of second shaft 18 of the base complex, gear 22 is free and rotates on gear 20, which is kept fixed on the support plate 5 by the racks of plates 29, 30. Consequently, gear 22 rotates in the same direction as disc 16 of the base complex.

The rotation of the free gear 22 on shaft 18 of the base complex causes a rotation in the opposite direction of gear 21 and, consequently, also of the first shaft 24 of the eccentric complex, which is fixed to it and which is the support and guide of disc 23 of the eccentric complex. Gear 22 allows therefore the transfer on an opposite rotation from disc 16 of the base complex to disc 23 of the eccentric complex.

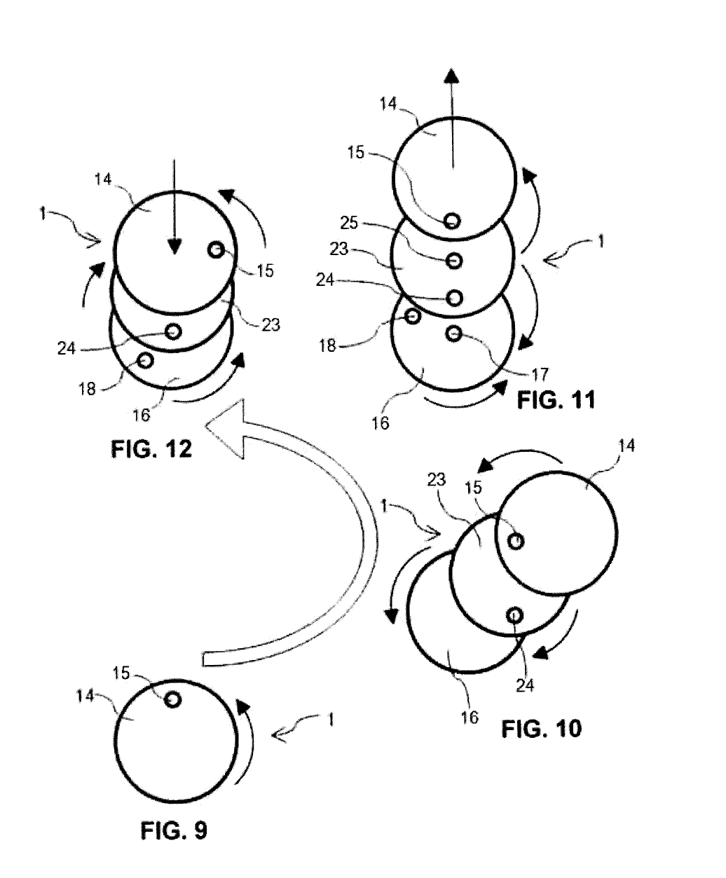

Disc 23 of the eccentric complex puts the second shaft 25 of the eccentric complex into motion and rotates shaft 15 of the massive disc 14 in a circular motion with the same rotational direction. The rotation of the second shaft 25 of the eccentric complex around the first shaft 24 of the eccentric complex causes the rotation of gear 27, which is fixed to the second shaft 25 of the same eccentric complex. Gear 27 rolls onto gear 26 (which is fixed in respect to disc 16 of the base complex, but free in respect to the first shaft 24 of the eccentric complex) and transfers the inverted motion to gear 28, fixed to shaft 15 of the massive disc 14 that guides the latter. Therefore, gear 27 conveys to disc 14 a movement of inverted phase in respect to disc 23 of the eccentric complex. The result is, for example, an anti-clockwise rotation of disc 16 of the base complex, a clockwise rotation of disc 23 of the eccentric complex and an anti-clockwise rotation of the massive disc 14, with an eccentric rotation of disc 23 of the eccentric complex in respect to disc 16 of the base complex and an eccentric rotation of the massive disc 14 in respect to disc 23 of the eccentric complex. Following this motion, disc 16 of the base complex, disc 23 of the eccentric complex and the massive disc 14 are overlapping at the beginning of every rotation (see FIG. 9-12).

After 90° the three discs 16, 23, 14 are clearly decoupled (FIG. 10), after 180° they reach their maximum extension (FIG. 11), and then they are decoupled again, but they are always aligned and they have doubled in speed at the end of the first period from 180° to 270° (FIG. 12) and finally they completely close and overlap again from 270° to 360° (FIG. 9).

Therefore, the massive disc 14 completely overlaps disc 16 of the base complex and on disc 23 of the eccentric complex at the beginning of the cycle, whereas at 180° from the previous position, it reaches the maximum extension. The overlapping and the extension of the eccentric discs 16, 23, 14 allow the motion inversions carried out by the two gears for motion inversion 22, 27. This movement cycle, if the junction segments of the eccentric holes are represented graphically, reminds us of the opening of a folding rule made of three wood segments (FIG. 18) where if the first segment rotates counterclockwise, the second (pivoted down), by opening it slowly it remains between 0° and 180°, always in the same position, because it moves and doesn't rotate, whereas the third one opens by following the anti-clockwise rotation of the first one. After half a round (180°) the rule will be completely extended and, going on with the same manoeuvre, it will rapidly close and come back to the starting position using the shortest way, that is the diameter of the circumference previously covered.

This representation clearly shows how, once 180° have been reached, the action of a phase manoeuvre to anticipate it by 90°, causes a considerable clockwise rotation of the central segment and therefore of the whole complex.

Disc 23 of the eccentric complex is fixed onto the first shaft 24 of the eccentric complex and has a clockwise rotation in respect to disc 16 of the base complex, following a circumference having as a reference the first shaft 24 of the eccentric complex. On the other hand, disc 16 on the base complex, having a complete anti-clockwise rotation around its first concentric shaft 17, foresees the symmetrical rotation of the massive disc 14. It rotates anti-clockwise around its shaft 15 located in an eccentric way in respect to disc 23 of the eccentric complex (that will seem only to shift), without changing direction on the circumference described by the first shaft 24 of the eccentric complex, as its clockwise rotation will be cancelled by the anti-clockwise rotation of disc 16 of the base complex.

Considering, for sake of simplicity, the mass of the massive disc 14, when the series of gears 19, 20, 21, 22, 26, 27, 28 direct it far from the mass centre, coinciding in the four eccentric groups 1, 2, 3, 4 with the beginning of the rotation with the first shaft 17 of the base complex, for the conservation of momentum principle, it would tend to keep its angular speed, but the constraint of the eccentric shaft 15, guides it into a curved trajectory, travelling along a semi-circumference, that decreases its speed in order to keep its angular momentum. Therefore only the transfer of an angular momentum supplied by a preferably electric engine, allows to the mass of the massive disc 14 to keep its angular speed and to receive the transfer of the angular momentum of the electric engine that it can used thanks to the rotation constraints, not more not less, as the distribution mechanism keeps the angular speed of the system stable (and therefore the surplus of energy demanded that can hence be used). The apparent violation of the conservation of the angular momentum, which instead has kept its angular speed, will be solved when it will be intended as a relative speed, perceived by an external observer, in comparison to the mass centre, that is the point where the mass of the system is considered to be concentrated. Therefore, if the eccentric rotation motion of the massive disc 14 in respect to the mass centre will be associated to the dragging motion of the rotation centre itself (due to the increase in momentum on the disc to keep the angular speed) the overall quantity of motion of the system will remain balanced, as the dragging will have consumed the obtained momentum.

Therefore the contribution of external momentum, which is supplied by the engine and assigned almost exclusively to the massive disc 14 in rotation and separated, alters the barycentre of the system and displaces the actual mass centre, because by generating control forces, it moves the structure linked to it in respect to an external observer, causes the dragging of the support point and consumes in this way all the momentum used.

In the second half of the rotation, when the massive disc 14 reaches its maximum extension and distance from the rotation centre and, by continuing its rotation, it comes back and closes itself on other discs, guided by distribution gears 19, 20, 21, 22, 26, 27, 28, it will find that the rotation centre has moved “forward” and sum up its advancement linear speed of advancement to its own speed in the opposite direction created by the mechanical constraints that with the decrease of the arm (the distance from the mass centre) have been caused thanks to a phase manoeuvre (an anticipation of 90°) carried out by cams 32, 33 (FIG. 19) on the plates 29, 30 equipped with racks of the necessary increase in angular speed, therefore allowing the conservation of the angular momentum, remaining after the dragging of the mass centre and allowing its consolidation. In this way the “angular speed” of the massive disc 14 will increase, accordingly to the conservation of angular momentum principle, for which the approaching of the mass to the rotation shaft is combined with an increase in the angular speed. In fact, both disc 23 of the eccentric complex and the massive disc 14 of each eccentric group 1, 2, 3, 4 will perform a perfectly semi-circular trajectory that, even if eccentric is referred to its shaft and the shaft of the system, it is characterised by a constant angular speed, so that they need to increase their angular momentum that is supplied by the electric engine. At 180°, the point of maximum extension, the imbalance of the barycentre of the system, caused by this considerable supply of momentum destined to a peripheral point of the system, far from the rotation centre, displaces the mass centre. Finally, the eccentric discs close again and travel along the diameter of the abovementioned circumference at an increasing speed, respecting the conservation of the angular momentum and allowing the consolidation of the displacement of the mass centre and not just a simple oscillation of restoration.

Two twins eccentric groups 1, 2 have opposite phases (clockwise and anti-clockwise rotation) and the other twin eccentric groups 3, 4 have a phase lag in respect to the first two, that is, they are out of phase by 180°.

This functional combination has created and also levels the side thrust combination and corrects the thrust period of the two eccentric groups 1, 2 at their maximum elongation, supporting their return phase thanks to the growing thrust of the other eccentric groups 3, 4.

As previously mentioned, gear 20 is still in respect to the support plate 5. In fact, gear 20 of each eccentric group 1, 2 and 3, 4 is blocked by one rack of the plates 29, 30 (FIG. 17). Gear 19, pivoting on the first shaft 17 of the base complex, is blocked by gear 20 and consequently it is also still in respect to the support plate 5. The two twin gears 19, 20 are therefore still till the activation of the stall device.

As mentioned above, the manoeuvres control structure allows it to modify the phase of the eccentric groups 1, 2, 3, 4. The activation of the racks of the first plate 29 delays the phase of the first eccentric group and in the same manner; it anticipates the phase of the second eccentric group, as the two eccentric groups are in counter-phase. At the same time the driver gear 6, moves the other rack plate 30 with the eccentric part of cam 32 and, thanks to its antagonist action in respect to the first rack plate 29, it is possible to simultaneously obtain the same manoeuvre on the remaining eccentric groups 3, 4, out of phase by 180° in respect to the first groups. Moreover, it is possible to obtain controlled steering movements towards right or left with small rotations of big or small intensity.

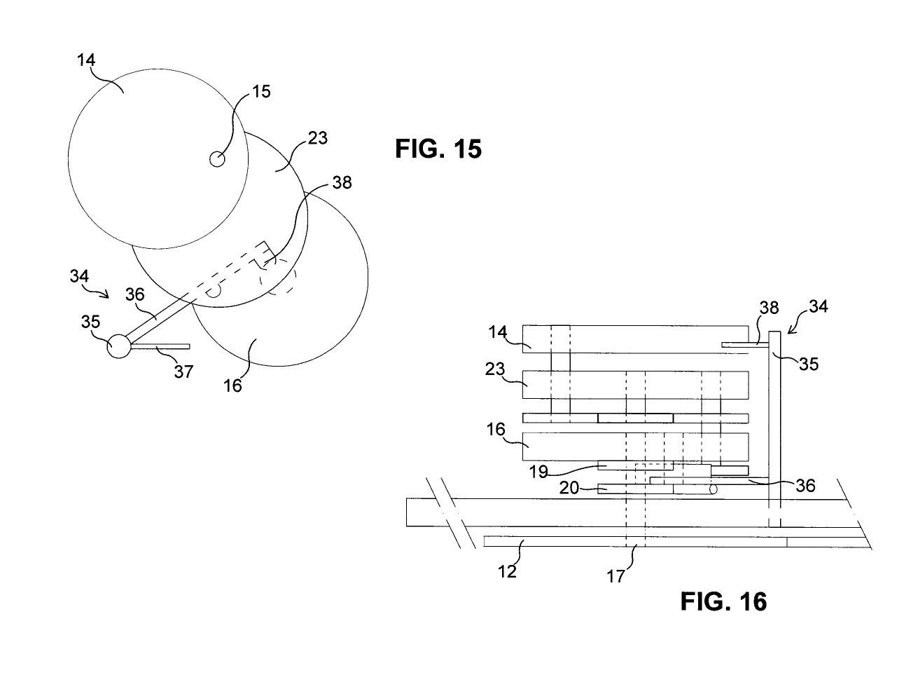

Thanks to this unified control system it is possible to effect this steering movement (FIG. 14) without physically intervene on the position of the support plate 5 or on its external fastening. It is only necessary to rotate the position of the four gears 20 by some degrees in respect to the support plate 5, operating consequently on the phase of the eccentric groups 1, 2, 3, 4 (which are its reference) with an adequate repositioning of the driver gear 6, as previously stated. The same system, by changing the phase advance of each eccentric group 1, 2, 3, 4 by 180°, produces a thrust inversion. It is also possible to obtain a stall of the eccentric groups 1, 2, 3, 4 (FIG. 15), thanks to the abovementioned stall mechanism. By activating the rocker 34, the second rocker arm 37 is positioned in a spot where it can be reached and operated by the massive disc 14. The profile of the massive disc 14, by using its extreme profile as a “cam nose”, pushes the second rocker arm 37, causing the rotation of the rocker 34 and consequently also that of the first rocker arm 36.

The rotation of the first rocker arm 36 takes its knife plate 38 between the two twin gears 19, 20 of an eccentric group 1, 2, 3, 4, by separating them (FIG. 16) and leaving gear 20 free, which is operated by the rack plates 29, 30, with any on-going manoeuvre, whereas gear 19, snap-released from its twin gear 20, stops on disc 16 of the base complex and becomes integral to it. This manoeuvre only happens when the massive disc 14 overlaps the other two discs 16, 23. Therefore, after this operation, gears 26, 19 (on which gears 27, 22 that transmit and invert motion) remain still in respect to them and to the first shaft of the eccentric complex that caused the motion of the eccentric complex itself. This keeps the eccentric group together in an undetermined way, with discs 16, 23, 14 overlapping, concentric and blocked as in a gyroscope, without generating any propulsion. In the same way, when rocker 34 (which has determined the separation of the two gears 19, 20) is at rest, the knife plate 38 disconnects from the two gears 19, 20 separated by it so that the spring, which was put under compression by plate 38, will start coupling gears 19, 20 again. The upper gear 20 becomes once more integral to its twin gear 19, by receiving the phase manoeuvres from the racks plates 29, 30 and by generating the rolling of gear 22 around itself with the operation of a normal cycle and elongation of the discs. The device is inserted on two metal carters, with a limit profile in the width and length of the support plate 5. The two metal carters make the device airtight and are equipped with perimeter eyelets to fasten to the vehicle or to the movable structure that it will have to push or rotate, by counterbalancing antagonist forces. Outside the two metal carters, there is an electric engine that can be inserted in Torx socket.

The movement useful to obtain the desired effect, is mainly that of the metal mass of the massive disc 14, that should have the highest possible density, by using particular materials and preferably Tungsten (wolfram), that has a fair hardness and resistance and a specific weight of 19.1 kg/dmc when pure, and of 17.6 if alloyed with nickel/steel. The other discs 16, 23 should however have a very low inertia, so that with equal dimensions and with a low density, they could be in titanium, which has a specific weight of 4.51 kg/dmc, a low density, and an ultimate strength similar to the one of mild steel. Alternatively, they can also be made in hardened aluminium, which has a specific weight of 2.71 kg/dmc. Shafts and gears are instead made in typical materials used in mechanical transmissions with high revs and highly stressed (steel C40).

As previously described, the propulsion created by this device is very high because the eccentric groups 1, 2, 3, 4 transform all the torque of the preferably electrical engine in thrust (net of friction), which is produced almost exclusively (75%) by the massive disc 14.

The high level of mechanization makes it possible to use only two modules of gears and just one dimension of discs 14, 16, 23. These discs receive the diameter dimension from the measure of the three gears of phase synchronisation arranged in line, whereas the support plate 5 has a dimension suitable to contain the groups 1, 2, 3, 4 at their maximum extension.

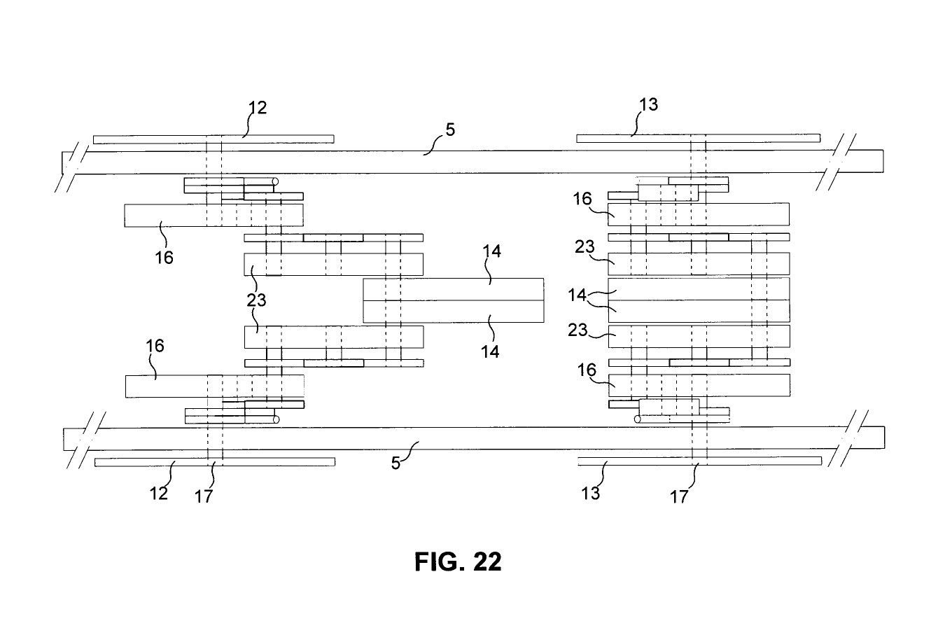

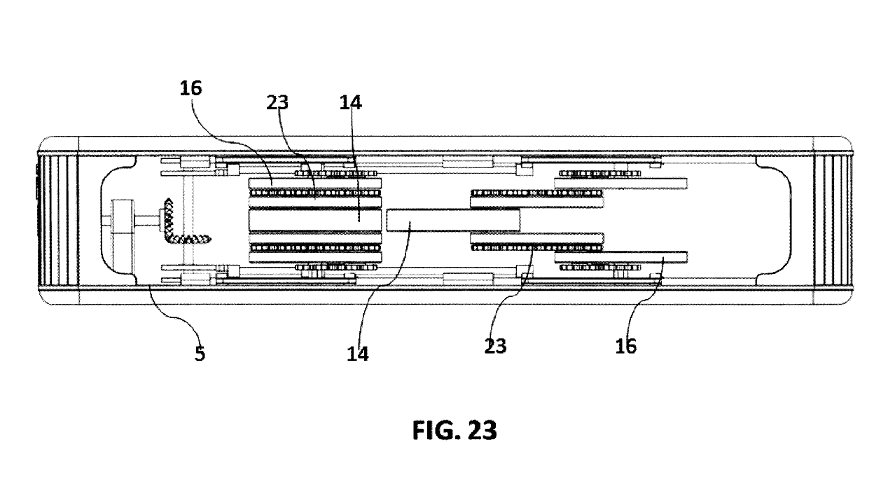

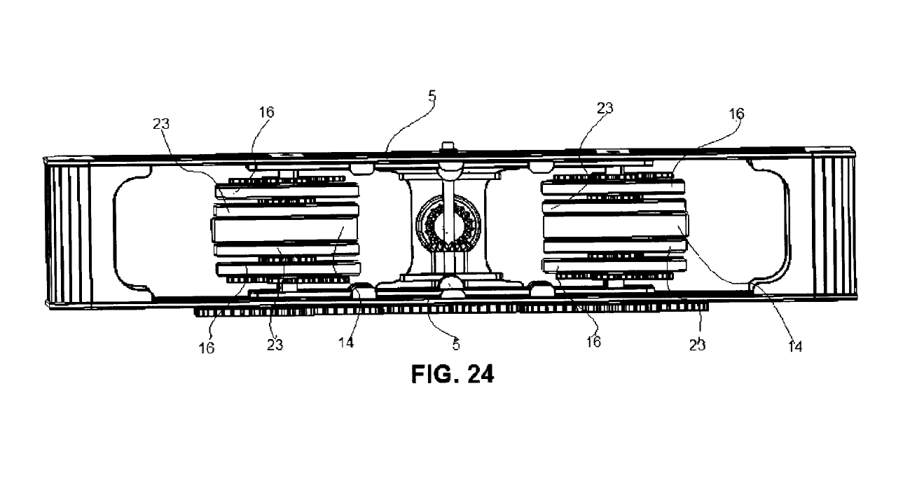

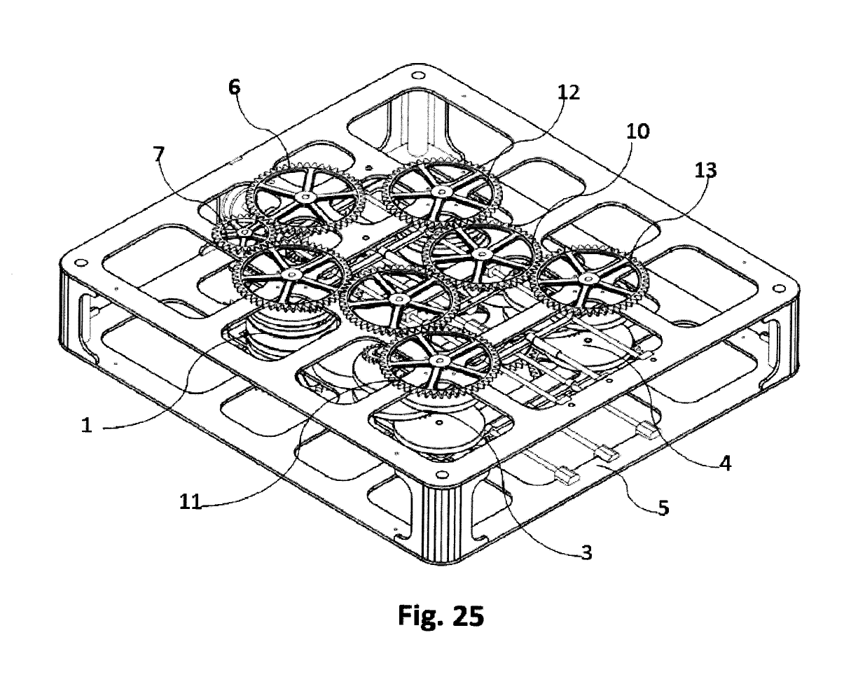

In this device, in a second execution example, two sets of four eccentric groups are symmetrically mounted on two support plates (FIG. 22-25). In this way the two massive discs 14 of the two symmetrical eccentric groups coincide and are coupled. As shown in FIG. 22-25, the two massive discs of the two symmetrical eccentric groups can be replaced by a single massive disc of double thickness.

The two plates 5 constitute for the longer sides of a solid metal structure that could have empty spaces at its sides (as in the example illustrated) for weight issue as well as being full. This metal structure can be enveloped by two metal carters that protect and seal the distribution gears, external to the support plates, thus making it airtight.

This disposition allows configurations with an extremely high number of revs as the central mass which thrusts the massive discs 14 is actually supported between the two support plates.

The thickness of the device corresponds to the distance between the two support plates 5, between which the eccentric groups 1, 2, 3, 4 and the manoeuvre control structures are interposed, in addition to the dimensions of the distribution gears.

The kinetic traction device, conceived in this manner, is subject to a number of further changes and variations, all included within the invention concept. Moreover all details can be replaced with other technical equivalents.

1. Kinetic traction device generated by eccentric motions and powered by an engine composed of at least four twin eccentric groups (1, 2, 3, 4), at least one support plate (5), a series of distribution gears (8, 9, 10, 11, 12, 13), at least one control structure of the phase manoeuvres and one stalling device for each eccentric group (1, 2, 3, 4); each support plate (5) is the base of at least four eccentric groups (1, 2, 3, 4); the above-mentioned distribution gears consist of one driver gear (6), at least one pinion (7), both pivoting on a support plate (5) each, at least a couple of crown wheels (9, 10) and at least four engine gears (8, 11, 12, 13); Each engine gear (8, 11, 12, 13) rotates an eccentric group (1, 2, 3, 4); the aforesaid distribution gears (8, 9, 10, 11, 12, 13) are placed at the same level; each eccentric group (1, 2, 3, 4) includes a base complex, a plate or a foil shaped as a massive disc (14) with a shaft (15) in which:
the base complex of each eccentric group (1, 2, 3, 4) includes a plate or a disc-shaped foil (16), the first shaft (17) of the base complex, the second shaft (18) of the base complex and four gears (19, 20, 21, 22); in the disc (16) of each base complex there is a central loop and two other holes both in eccentric position and placed at the vertex of an equilateral triangle, having as its third vertex the central hole; the first end of the abovementioned first shaft (17) of the base complex goes through a hole in the support plate (5), whereas the other end is inserted in the aforesaid central hole in the disc (16) of the complex and it is orthogonally secured to the disc (16) itself; the first end of the abovementioned first shaft (17) of the base complex is linked to an engine gear (8, 11, 12, 13); the first end of the second shaft (18) of the base complex (secured to disc 16 itself) is placed in the aforesaid second hole in disc (16) of the base complex; at the second end of the second shaft (18) of the base complex a first gear (22) is free; this first gear (22) of the base complex works on a second gear (19) of the base complex pivoting on the first shaft (17) of the base complex; the second gear (19) of the base complex is secured to a third gear (20), which is fitted to the first shaft (17) of the base complex;
each eccentric complex of each eccentric complex (1, 2, 3, 4) includes a plate or a disc-shaped foil (23), a first shaft (24) of the eccentric complex, a second shaft (25) of the eccentric complex and three gears (26, 27, 28); this disc (23) of each eccentric complex has three holes: in the first eccentric hole, the first end of the first shaft (24) is fastened; in the first end of the second shaft (25) is secured to the second central hole of the disc (23); in the third hole, the abovementioned shaft (15) of the third massive disc (14) rotates freely in respect to disc 23 of the eccentric complex; shaft 15 is integral to the massive disc (14) itself and supports and guides it; the three holes of disc (23) of the eccentric complex are placed having the same diameter: the first hole is opposite the third one in respect to the second hole; the second end of the first guide shaft (24) of the eccentric complex goes through the second eccentric hole of the disc (16) of the base complex; the first guide shaft (24) of the eccentric complex is able to rotate freely in respect to disc (16) of the base complex; this first gear (22) free on the second shaft (18) of the base complex is also linked to the fourth gear (21) of the base complex, which is secured to an end of the first guide shaft (24) of the eccentric complex; this first guide shaft (24) of the eccentric complex goes through the first gear (26) of the eccentric complex, which is secured to the disc (16) of the base complex; such first gear (26) of the eccentric complex is engaged to the second gear (27) of the eccentric complex that transfers and inverts the motion, which pivots round the second end of the second shaft (25) of the eccentric complex; this second gear (27) for the inversion of the eccentric complex is linked to the third gear (28) of the eccentric complex, which is secured to an end of the shaft (15) of the massive disc placed between disc (16) of the base complex and disc (23) of the eccentric complex;
shaft (15) of the massive disc rotates freely in respect to the disc (23) of the eccentric complex and constitutes as a support and guide to the massive disc (14), which is integral to it;
said stall mechanism consists of a rocker (34) for each eccentric group (1, 2, 3, 4); each rocker (34) is composed of a shaft (35) secured to the support plate (5), on which the first rocker arm (36) and the second rocker arm (37) are fastened; this rocker (36) is positioned between the first gear (19) and the second gear (20) of the first shaft (17) of the base complex; a knife plate (38) is fixed to the first rocker (36) and a spring which is connected to the support plate (5) is linked to the second rocker (37); the second rocker (37) is located in a spot where it that can be easily reached and operated on from the massive disc (14) at the end of its rotation;
the propulsion mechanism is characterised by the fact that two sets of twin eccentric groups (1, 2, 3, 4) are mounted in a specular way on two support plates (5), so that the massive discs (14) of two symmetrical eccentric groups can coincide and are paired together and by the fact that:
said abovementioned control structure of the phase manoeuvre includes for each support plate (5) two plates (29, 30) with at least two couples of toothed racks on two sides, operated by means of cams (32, 33); these cams (32, 33) are positioned in pairs and rotate integral to the driver gear (6); the two cams (32, 33) are out of phase by 180° from one another; the plates (29, 30) with couples of racks are positioned on the first side of the support plate (5) on which the eccentric groups are mounted (1, 2, 3, 4); the racks are positioned at the same level as the cams (32, 33); the plates (29, 30) with couples of racks are coupled to each support plate (5) by means of sliding joints (31), which allows it to only move in one direction; every cam (32, 33) is directly plated in touch with one plate (29, 30) with couples of racks; their contact is assured by the presence of compression springs; the driver gear (6) acts simultaneously by means of its two cams (32, 33) on the couple of plates (29, 30) with racks, each of them touches two sides the opposing sides of the gears (20) of the eccentric groups (1, 2, 3, 4); in more detail, one plate (29) with racks touches the gears (20) of two eccentric groups (1, 2) and the other plate (30) with racks touches the gears of the other eccentric groups (3, 4); this third gear (20) is fitted to the first shaft (17) of the base complex of each eccentric group (1, 2, 3, 4) and is blocked in respect to the support plate (5) of the plates (29, 30) with racks and is displaced only by the phase manoeuvres.

2. The kinetic traction device of claim 1, characterised by the fact that disc (16) of the base complex, disc (23) of the eccentric complex and the massive disc (14) are in metal and have the same diameter.

3. The kinetic traction device of claim 1, characterised by the fact that each plate or foil of the base complex, eccentric complex or massive eccentric has a different shape to each one of the disc.

4. The kinetic traction device of claim 1, characterised by the use of a high density material for each massive disc (14) and low density materials for each disc (16) of the base complex and for each disc (23) of the eccentric complex.

5. The kinetic traction device of claim 1, characterised by the fact that each one of the two sets of twin eccentric groups (1, 2, 3, 4), is symmetrically mounted on two support plates (5) and consists of two couples of eccentric groups (1, 2, 3, 4) in which each couple of eccentric groups (1, 2, 3, 4) is out of phase by 180° in respect to the other couple.

6. The kinetic traction device of claim 1, characterised by the fact that each one of the two sets of twin eccentric groups (1, 2, 3, 4) which has been symmetrically mounted on the two support plates (5) includes three pairs of eccentric groups (1, 2, 3, 4) in which each pair of eccentric groups (1, 2, 3, 4) is out of phase by 120° in respect to the other pairs.

7. The kinetic traction device of claim 1, characterised by fact that each one of the two sets of twin eccentric groups (1, 2, 3, 4) which has been symmetrically mounted on two support plates (5) consists of four pairs of eccentric groups (1, 2, 3, 4) in which each pair of eccentric groups is out of phase by 90° in respect to the other pairs; each set of eccentric groups (1, 2, 3, 4) is placed on the corresponding support plate (5) at the corners of a virtual square.

8. The kinetic traction device of claim 1, characterised by the fact that two massive discs (14) of two symmetrical eccentric groups (1, 2, 3, 4) are replaced by a single massive disc of double thickness.

9. The kinetic traction device of claim 1, characterised by fact that each one of the two sets of twin eccentric groups (1, 2, 3, 4) symmetrically mounted on two support plates (5) includes more than four couples of eccentric groups (1, 2, 3, 4).

10. The kinetic traction device of claim 1, characterised by fact that the plates (29, 30) with racks are operated by electro-hydraulic or electro-mechanical actuators.
